(19) United States
(12) Patent Application Publication
(10) Pub. No.: US 2007/0036037 A1
(43) Pub. Date: Feb. 15, 2007

(54) CLIPABLE TIMEPIECE

(75) Inventors: Stefane Barbeau, Roxbury, MA (US); Daniel Reilly, Jamaica Plain, MA (US); Daune Smith, Roxbury, MA (US)

Correspondence Address: LAW OFFICE OF A.P. DURIGON, 20 EUSTIS STREET, CAMBRIDGE, MA, 02140, US

(73) Assignee: VESSEL, INC., Boston, MA (US)

(21) Appl. No.: 11/161,687

(22) Filed: Aug. 12, 2005

(51) Int. Cl. G04B 37/00

(52) U.S. Cl. 368/316

(57) ABSTRACT

A time module including a timepiece display is carried by a mechanical spring between its opposing resilient spring arms providing a clip formed between one resilient spring arm and the confronting surface of the casing enabling clip attachment to any flexible thin sheet material and enabling viewing of the timepiece display at the other of the resilient spring arms while clip attached to the flexible material.

### FIELD OF THE INVENTION

This invention is drawn to the field of article carriers, and more particularly, to a novel clipable timepiece.

### BACKGROUND OF THE INVENTION

Typically, timepieces have been designed to be worn on the wrist, carried in a pocket, mounted on a wall, supported on a table or designed for some other special purpose application. Such special purpose timepieces, however, enjoy limited versatility. Moreover, the special purpose timepieces are often bulky or otherwise obtrusive or aesthetically unappealing, as their special purpose application often dominated their formal expression.

### SUMMARY OF THE INVENTION

Accordingly, it is the principal object of the present invention to disclose a clipable timepiece that is versatile, inconspicuous and decorative.

In accord with the present invention, a clipable timepiece is disclosed that includes a mechanical spring having generally opposing, laterally-spaced resilient spring arms; and a time module including a time display carried by the mechanical spring between its resilient spring arms and cooperative therewith to allow viewing of the time display through one of the resilient arms and to provide a clip constituted by the other of the resilient arms and the confronting surface of the time module adapted to slidably receive and resiliently clasp a sheet of flexible material therebetween without penetrating the sheet of flexible material.

In this manner, the clipable timepiece of the present invention may be made desirably small and decorative while being clipably attached versatilely to any flexible sheet material such as the sleeve of a T-shirt or lapel of a suit, to the flap of a handbag or purse strap or other personal accessory, to the pages of a notebook, or to any other flexible material without penetrating or otherwise damaging the material.

The clipable timepiece of the present invention preferably is at least water-resistant and capable of single button time setting.

The presently preferred clock function preferably is provided by an integrated circuit and LCD display powered by a replaceable battery carried by and mounted within the time module although a temperature sensing integrated circuit and associated display, or a Wi-Fi signal presence indicating integrated circuit and associated display, or other integrated circuit or other information display means or method could be used to provide a versatile, inconspicuous and decorative clipable digital information display in accord with the present invention.

### BRIEF DESCRIPTION OF THE DRAWINGS

These and other objects, inventive aspects and advantageous features of the present invention will become apparent as the invention becomes better understood by referring to the following, solely exemplary detailed description of the presently preferred embodiments thereof, and to the drawings, wherein:

FIG. 1 is an isometric view of the clipable timepiece of the present invention;

FIG. 2 is a side view thereof;

FIG. 3 is a pictorial view showing the clipable timepiece on the sleeve of a T-shirt;

FIG. 4 shows the clipable timepiece on paper sheets;

FIG. 5 shows the same on a lanyard worn about the neck;

FIG. 6 is an exploded perspective view of the clipable timepiece of the present invention; and

FIG. 7 in the FIGS. 7A, 7B, 7C thereof shows isometric and top views of the clipable timepiece useful in explaining the manner that the time is preferably set by depression of a single button.

### DETAILED DESCRIPTION OF THE PRESENTLY PREFERRED EMBODIMENTS

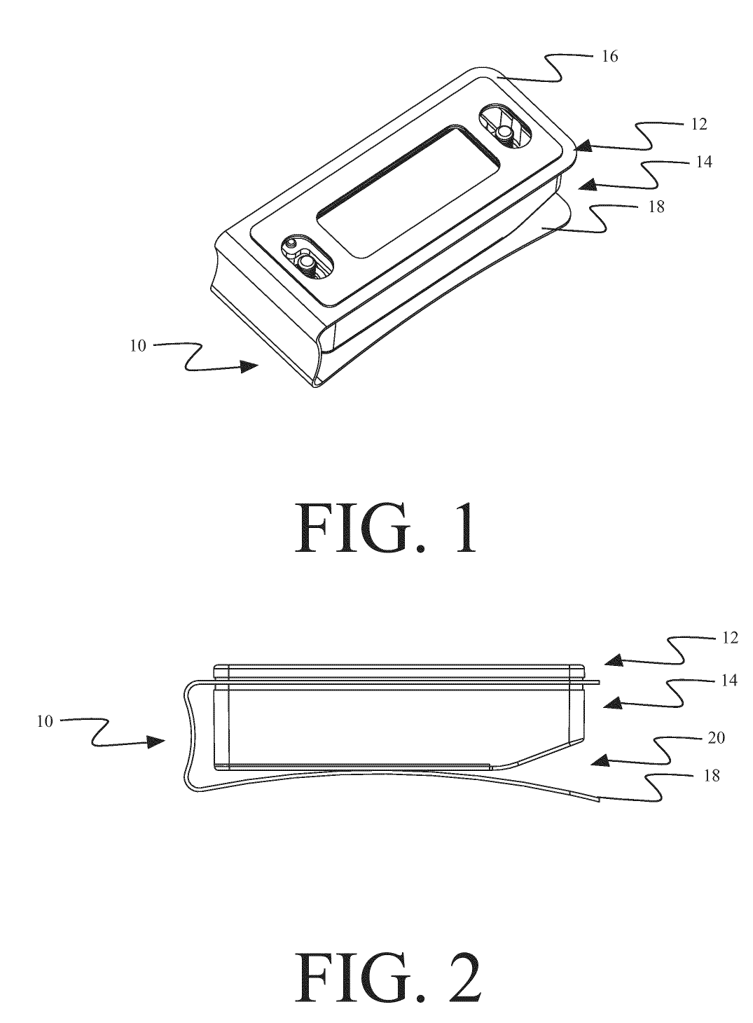

Referring now to FIG. 1, generally designated at 10 is an isometric view showing a presently preferred clipable timepiece embodiment in accord with the present invention. The clipable timepiece 10 includes a mechanical spring generally designated 12 and a time module generally designated 14 carried by the mechanical spring 12 between opposing resilient spring arms 16, 18 of the mechanical spring 12. As best seen in FIG. 2, the resilient spring arm 18 of the mechanical spring 12 is cooperative with the confronting surface of the time module 14 to provide a clip generally designated 20 adapted to receive and clasp flexible sheet material therebetween without damaging the same. The resilient spring arm 16 of the mechanical spring 12 and time module 14 are cooperative to provide a window generally designated 22 displaying the time.

In one presently preferred embodiment of the clipable timepiece in accord with the present invention, the mechanical spring 12 is fashioned of a single length of “305” stainless spring steel so bent as to provide the resilient spring arms 16, 18, and the walls of the time module 14 are fashioned of clear polycarbonate. As will be appreciated, the web joining the spring arms 16, 18 determines their resiliency in a manner well-known in the spring art. As will be readily seen and appreciated, the clipable timepiece 10 is aesthetically pleasing and decorative, and sized to be unobtrusive, 0.45 W*1.1 H*0.3 D inches, in one presently preferred embodiment.

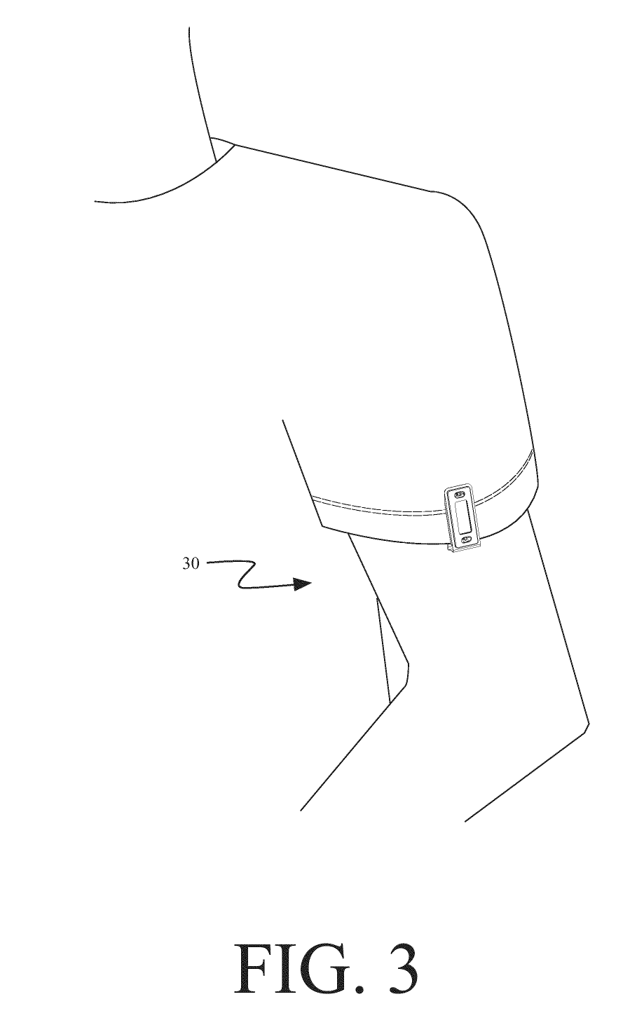

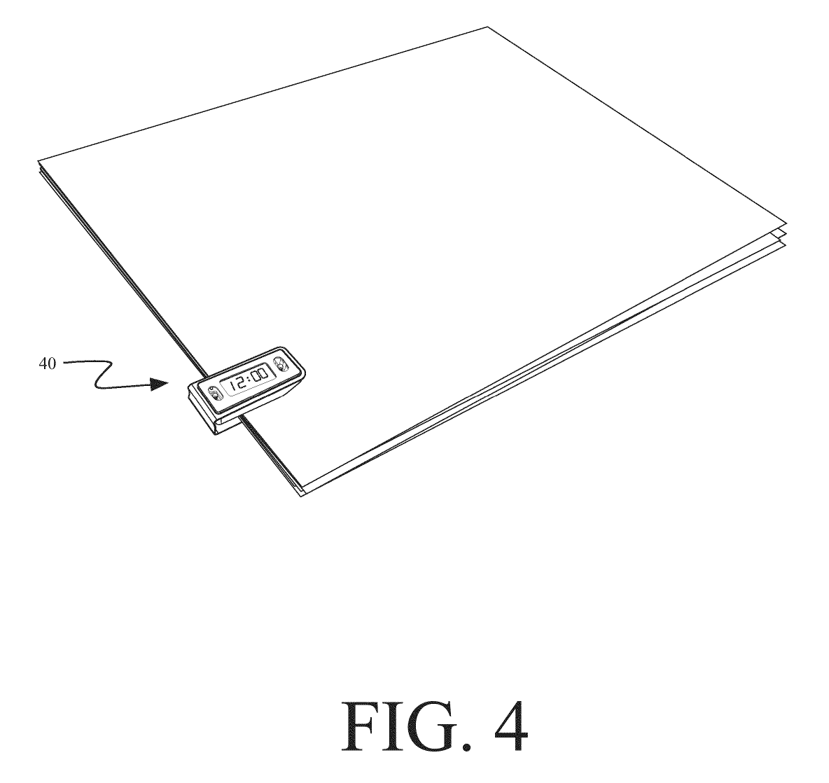

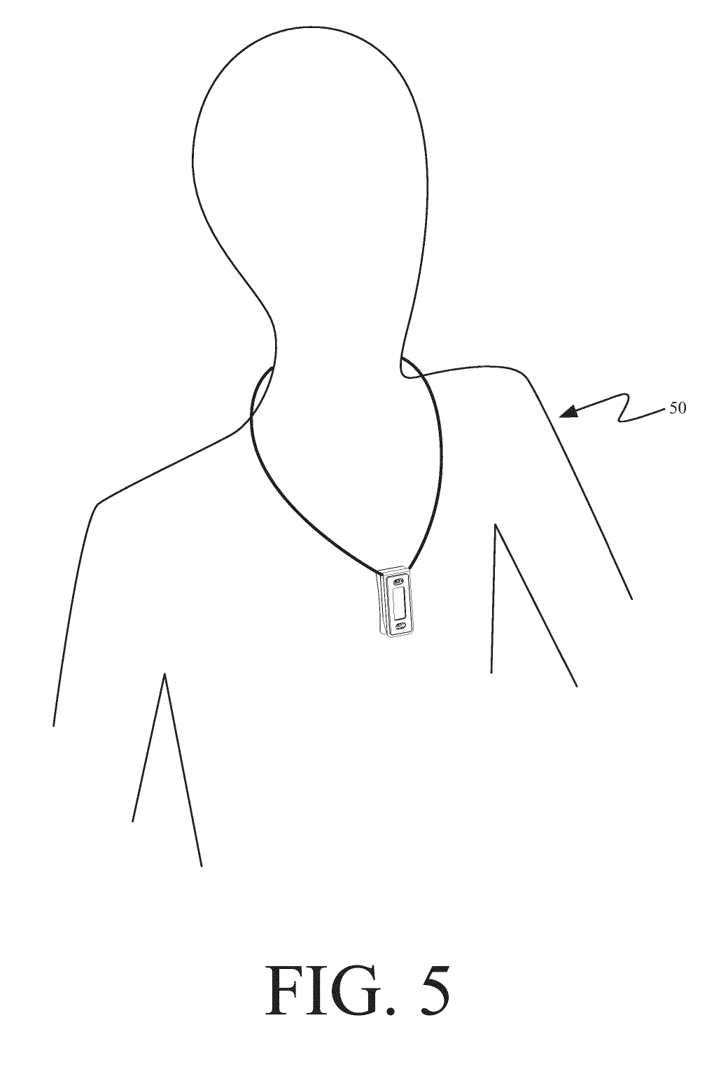

The clip 20 permits versatile attachment to flexible sheet material without damaging the same, such as being clipped to the sleeve of a T-shirt as illustrated generally at 30 in FIG. 3, or being clipped to paper sheets as illustrated generally at 40 in FIG. 4, or by being worn on a lanyard as generally illustrated at 50 in FIG. 5. It will be understood, of course, that the versatility of the clipable timepiece 10 in accord with the present invention is not limited to these examples but may appropriately be worn or tagged wherever or whenever it is useful or desirable to have a time note, such as on bed clothing, book jackets, or in the bathroom, or on sport and leisure accessories, such as beach or golf bags, in the kitchen such as on aprons, recipe books and tablecloths, and, for example, on lab coats clip boards and the like.

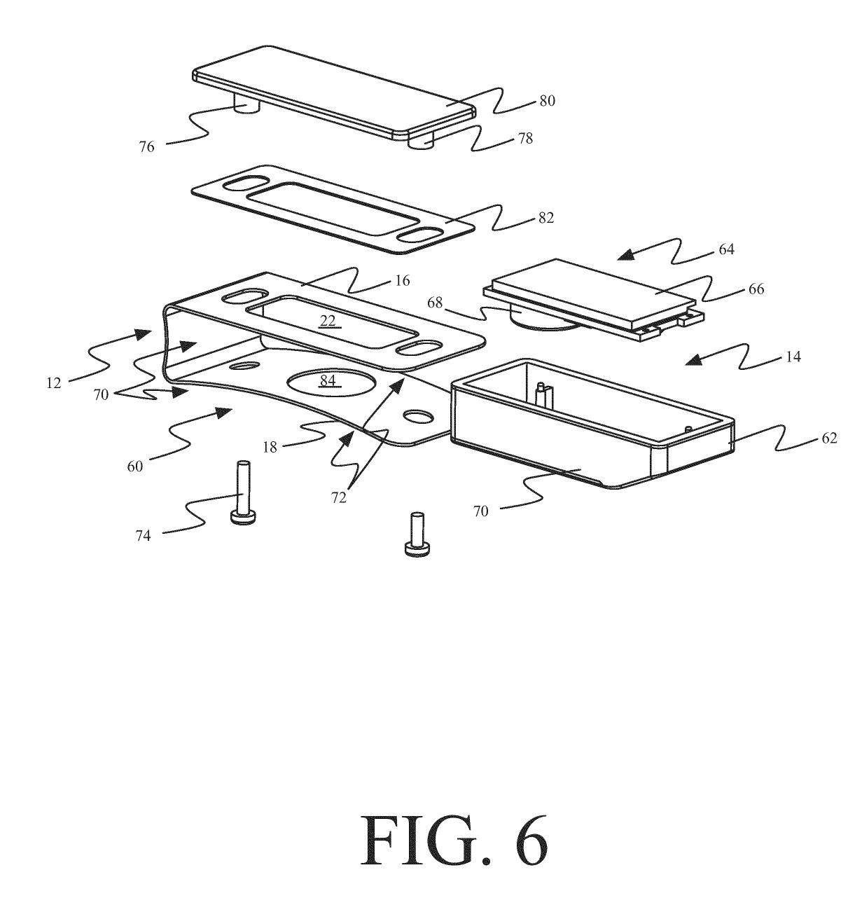

Referring now to FIG. 6, generally designated at 60 is an exploded perspective view of the clipable timepiece in accord with the present invention. The time module 14 of the clipable timepiece 60 includes a bucket 62 in which a printed circuit board generally designated 64 having a liquid crystal display 66 and a replaceable battery 68 are removably mounted.

A rubber overmold 70 on the bucket 62 of the time module 14 provides four (4) major functions. The rubber overmold 70 seals the attachment and contact interfaces between the time module 14 and the mechanical spring 12 to provide, in dependence on the degree of sealing, a water resistant and/or water proof timepiece. The rubber overmold 70 also provides friction to prevent unintentional release of a flexible substrate received within and clasped by the clip provided by the resilient spring arm 18 of the mechanical spring 12 and the confronting surface of the bucket 62 of the time module 14. The rubber overmold 70 also provides a flexible cover permitting one-touch time setting in a manner to be described. Additionally, the rubber overmold 70 helps absorb mechanical shock when joining the time module 14 and mechanical spring 12 during initial assembly, or when the battery 68 needs to be replaced.

The resilient spring arms 16, 18 of the mechanical spring 12 are provided with aligned apertures generally designated 70, 72 to either side of the view window 22. The time module 14 carried by the mechanical spring 12 between the resilient spring arms 16, 18 preferably is fastened to the spring arm 16 by threaded fasteners 74 that pass through the aligned openings 70, 72 and are captured in threaded bosses 76, 78 of transparent cover 80. The threaded fasteners 74 pass through openings, not shown, provided therefor in the bottom of the bucket 62 of the time module 14. The openings 70, 72 on the arm 18 also allow fabric (or other soft sheet material) to slightly protrude therethrough, which helps to prevent its unintentional release.

A seal 82 is provided between the transparent cover 80 and the confronting surface of the resilient spring arm 16 of the mechanical spring 12. The seal 82 also absorbs mechanical shock. Preferably, the seal 82 is fashioned of silicon.

The time module 14 may be released from the mechanical spring 12 by unscrewing the fasteners 74 using a small screwdriver inserted through the apertures 70, 72 and withdrawing the bucket 62 out from between the opposing resilient spring arms 16, 18. The printed circuit board 64 may then be removed and the battery 68 removed and replaced.

An opening 84 is provided in the resilient spring arm 18 to allow single-button time setting in a manner to be described.

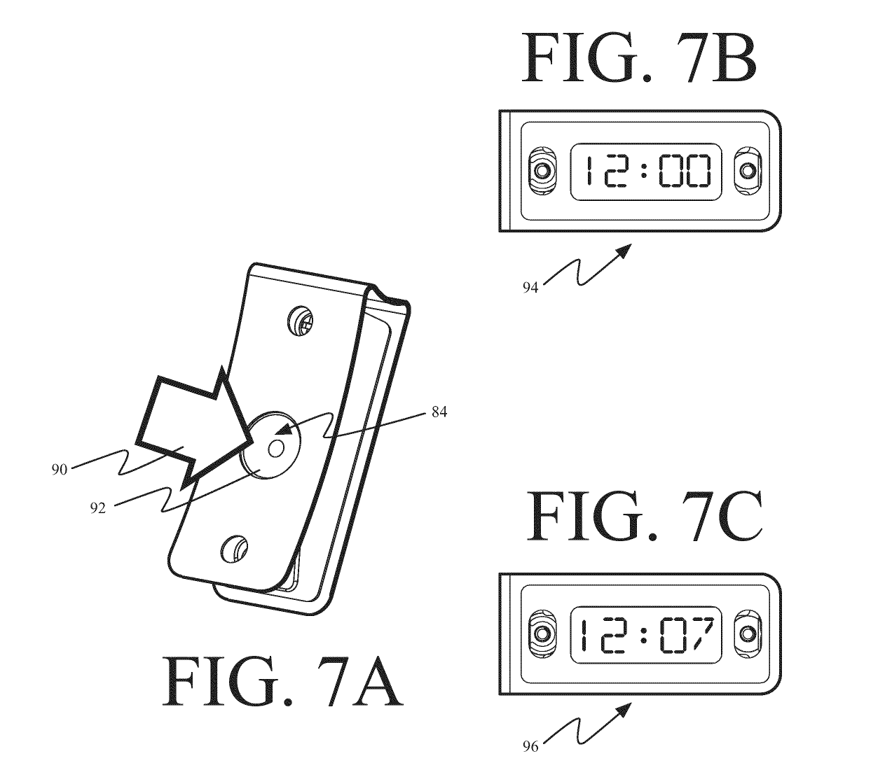

With reference now to FIG. 7, the presently preferred single-button time setting function will now be described. As illustrated by arrow 90 in FIG. 7A, a pen or other pointed implement is pushed against the rubber overmold 92 through the opening 84, thereby actuating a time button, not shown, provided therefor on the printed circuit board 64 (FIG. 6) releaseably mounted in the bucket 62 (FIG. 6) of the time module 14. Pressing and holding the button scrolls the time as shown generally at 94, 96 in FIGS. 7B, 7C; releasing the time button will stop scrolling. In one presently preferred embodiment, the clock scrolls through sixty (60) minutes in five (5) seconds; the scroll speed doubles after three (3) seconds of constant scrolling. The time setting is accepted after five (5) seconds of rest. Momentarily pressing the button will cause the minutes to jump by a single digit. Of course other time display or scrolling protocols may be employed.

Many modifications of the presently disclosed invention will become apparent without departing from the inventive concepts.

What is claimed is:

1. A clipable timepiece that is versatile, inconspicuous and decorative, comprising:
a mechanical spring having generally opposing, laterally-spaced resilient spring arms; and
a time module including a time display carried by the mechanical spring between its resilient spring arms and cooperative therewith to allow viewing of the time display through one of the resilient arms and to provide a clip constituted by the other of the resilient arms and the confronting surface of the time module that is adapted to slidably receive and resiliently clasp a sheet of flexible material therebetween without penetrating the sheet of flexible material.

2. The clipable timepiece that is versatile, inconspicuous and decorative of claim 1, wherein the time module includes a casing and an integrated circuit and LCD display powered by a replaceable battery carried by and mounted within the casing of the time module.

3. The clipable timepiece that is versatile, inconspicuous and decorative of claim 1, wherein said mechanical spring is fashioned of spring steel that is so bent on itself as to provide said generally opposing, laterally-spaced resilient spring arms.

4. The clipable timepiece that is versatile, inconspicuous and decorative of claim 1, wherein said time module includes a bucket fashioned of transparent polycarbonate material.

5. The clipable timepiece that is versatile, inconspicuous and decorative of claim 4, wherein a rubber overmold is attached over said bucket to provide at least a watertight seal between the contacting interfaces of the mechanical spring and time module and wherein a transparent window and gasket seal are attached to said one of said resilient arms allowing viewing of the time display to provide at least a watertight seal of said time display.

6. The clipable timepiece that is versatile, inconspicuous and decorative of claim 5, wherein said rubber overmold is adapted to frictionally resist withdrawal of said sheet of flexible material from said clip to prevent unintentional release.

7. A clipable article displaying preselected information that is versatilely useable on a variety of flexible substrates while being inconspicuous and decorative, comprising:
a mechanical spring having generally opposing, laterally-spaced resilient spring arms; and
an information module including a circuit adapted to display predetermined information carried by the mechanical spring between its resilient spring arms and cooperative therewith to display said predetermined information and to provide a clip constituted by one of said resilient spring arms and the confronting surface of the information module that is adapted to receive and clasp a sheet of flexible material therebetween without penetrating the sheet of flexible material.

8. The clipable article displaying preselected information of claim 7, wherein said information module includes an integrated circuit adapted to display the time.

9. The clipable article displaying preselected information of claim 8, wherein said integrated circuit is further adapted to set the time in response to controlled depression of a single button.

10. The clipable article displaying preselected information of claim 7, wherein said information module includes an integrated circuit adapted to display Wi-Fi signal presence.

11. The clipable article displaying preselected information of claim 7, wherein said information module includes an integrated circuit adapted to display temperature.

12. A clipable timepiece, comprising:
a mechanical spring having opposing resilient spring arms;
a casing carried by the mechanical spring between the resilient spring arms thereof having opposing faces such that one of the resilient spring arms of the mechanical spring and the confronting surface of one of the opposing faces of the casing provide a clip adapted to receive thin flexible material and clasp the same therebetween without penetrating the flexible material;
an integrated circuit implementing a clock function operatively connected to an LCD adapted to display the time and a battery mounted to said casing such that the LCD is exposed at the other of said opposing faces of said casing;
a transparent window having at least one threaded boss;
said resilient spring arms each have at least one aperture aligned with each other and with said at least one threaded boss adapted to threadably fasten said casing to the underside of the other one of said resilient spring arms and to threadably fasten said transparent window to the topside of the same arm over said exposed LCD.

13. The clipable timepiece of claim 12, wherein said battery is a replaceable battery.

14. The clipable timepiece of claim 12, wherein means are provided for sealing the casing against water seepage.

15. The clipable timepiece of claim 14, wherein said sealing means includes a rubber overmold attached to said casing.

16. The clipable timepiece of claim 12, wherein said integrated circuit implementing a clock function is setable by actuation of a single button.
